(19) United States
(12) Patent Application Publication
(10) Pub. No.: US 2009/0208900 A1
(43) Pub. Date: Aug. 20, 2009

(54) Bifunctional dental apparatus

(76) Inventor: Leon Emmanuel Jew, Hayward, CA (US)

Correspondence Address: DAHYEE LAW GROUP, 5776 Stoneridge Mall RD, SUITE288, Pleasanton, CA, 94588, US

(21) Appl. No.: 12/070,654

(22) Filed: Feb. 20, 2008

(51) Int. Cl. A61C 17/00

(52) U.S. Cl. 433/92

(57) ABSTRACT

The invention teaches an apparatus used in dental care service for providing gaseous oxygen to a patient and removing dental impurities from the patient's mouth concurrently. The apparatus includes a first bendable nozzle for dispensing gaseous oxygen to a space near the patient's nose and a second bendable nozzle for sucking dental impurities from the patient's mouth.

### FIELD OF ART

The invention relates to an apparatus used in dental care service for providing gaseous oxygen to a patient under dental care service and removing dental impurities from the patient's mouth concurrently.

### BACKGROUND OF ART

It has been a routine practice in dentistry that the dental impurities created during a dental operation such as teeth cleaning are removed by a vacuum suction by gently inserting the suction nozzle in the patient's mouth.

It is not enjoyable for any one being limited to a dental bed for dental service with his or her mouth open for a period of time. Especially for seniors or for these who have heath problems such as high blood pressure, the dental care service can be a tedious and hard time.

Thus there is a need for an easy-for-use apparatus, with which the dental professional may provide oxygen-enriched air to a patient under dental care service while removing dental impurities from the patient's mouth.

### SUMMARY OF THE INVENTION

The invention teaches an apparatus used in dental care service for providing gaseous oxygen to a patient and removing dental impurities from the patient's mouth concurrently. The apparatus includes a light-weight neck with a first bendable nozzle and a second bendable nozzle, a base comprising a source of oxygen and a vacuum suction, and a flexible connector coupled between the neck and the base. The flexible connector includes a first inner path for dispensing gaseous oxygen from the source of oxygen to the patient's nose through the first nozzle and a second inner path for sucking dental impurities from the patient's mouth through the second nozzle. Each of the first nozzle and the second nozzle may have a disposable extension for hygienic purpose. The nozzle extensions are discarded after the dental service is done for the patient. The connector having the first inner path for dispensing gaseous oxygen and the second inner path for sucking dental impurities is preferably transparent or semi-transparent flexible rubber pipe.

### BRIEF DESCRIPTION OF THE DRAWINGS

FIG. 1 is a schematic diagram illustrating a bi-functional dental apparatus with an outlet nozzle for dispensing gaseous oxygen and an inlet nozzle for removing dental impurities from a patient's mouth according to the invention.

### DESCRIPTION OF THE INVENTION

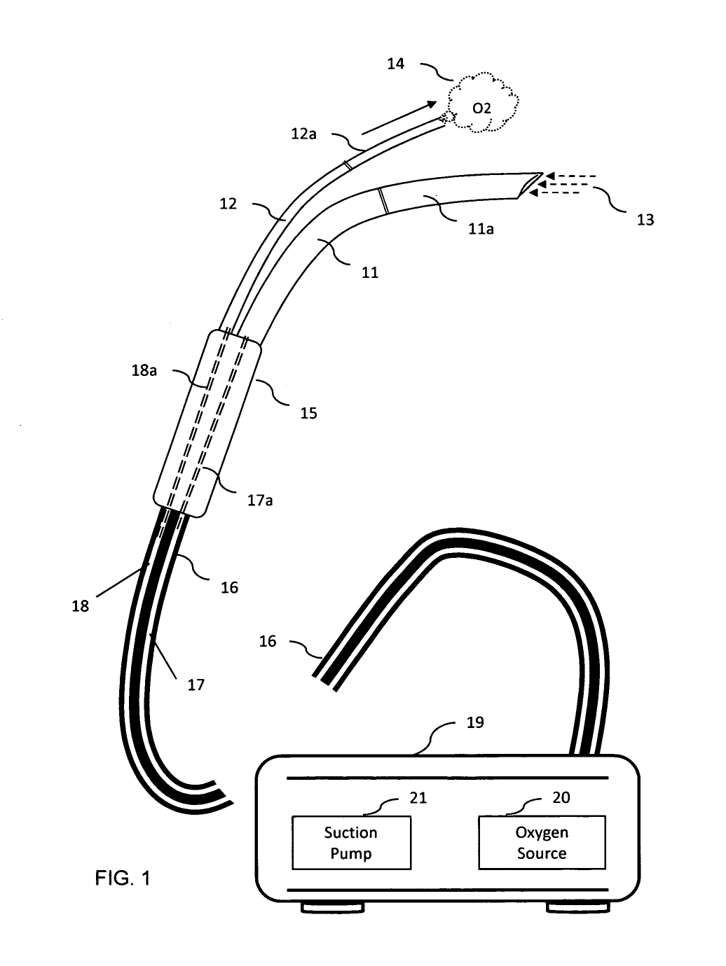

As illustrated in FIG. 1, the bi-functional dental apparatus according to the invention includes:

1. A base 19, which is an electrical and mechanical assembly including a vacuum suction pump 21 and a source of oxygen 22. The oxygen source 22 may be a canister of gaseous oxygen or any type of oxygen generator.

2. A flexible connection means 16, which includes a first inner path 18 coupled to the oxygen source 20 in the base 19, and a second inner path 17 coupled to the suction pump 21. The connection means 16 is preferably a flexible transparent or semi-transparent rubber pipe with two inner paths, one being the path 17 for transporting impurities, and the other being the path 18 for releasing gaseous oxygen.

3. An inlet member 11, working as a sucking nozzle, for sucking the dental impurities 13 from the patient's mouth. The inlet member 11 is preferably a bendable transparent or semi-transparent pipe. For the purpose of this invention, “bendable” means that the direction or position of the inlet member 11 can be adjusted by bending a part of it using a slight manual force.

4. An outlet member 12, working as a dispensing nozzle, for dispensing gaseous oxygen 14 to a space near the patient's nose. For the purpose of this invention, the gaseous oxygen can be substituted by oxygen-enriched air, or air comprising oxygen or other beneficial gases. The outlet member 12 is preferably a bendable transparent or semi-transparent pipe. For the purpose of this invention, “bendable” means that the direction or position of the outlet member 12 can be adjusted by bending a part of it using a slight manual force. The outlet member 12 is preferably thinner than the inlet member 11. In implementation, the outlet member 12 may be in a color different from that of the inlet member 11.

5. An optional neck 15 which is a light-weight member coupled between the flexible connection means 16 and the nozzles (i.e., the outlet member 12 and the inlet member 11). The neck 15 includes the inner path 18a for connecting the outlet member 12 to the inner path 18, and the inner path 17a for connecting the inlet member 11 to the inner path 17. In the basic implementation, the neck 15 is not necessary. In that case, the nozzle 12 directly coupled to the inner path 18, and the nozzle 11 is directly coupled to the inner path 17. The neck 15 may be transparent or semi-transparent such that the inner paths are visible.

6. Optionally, a removable and disposable extension 12a may be adapted to the outlet member 12 for hygienic purpose. After using on one patient, the dental professional may simply remove the extension 12a from the outlet member 12 and discards it. A brand new disposable extension 12a will be used for another patient. To avoid confusion or misuse, the extension 12a is preferably in a color matching to the color of the outlet member 12. For example, the color of the extension 12a is same or substantially same as the color of the outlet member 12.

7. Optionally, another removable and disposable extension 11a may be adapted to the inlet member 11 for hygienic purpose. After using on one patient, the dental professional may simply remove the extension 11a from the inlet member 11 and discards it. A brand new disposable extension 11a will be used for another patient. To avoid confusion or misuse, the extension 11a is preferably in a color matching to the color of the inlet member 11. For example, the color of the extension 11a is same or substantially same as the color of the inlet member 11.

In operation, the dental professional bends and adjusts the inlet member 11, and properly places it in the patient's mouth. The dental impurities are removed and sucked to a container installed in the base 19 via the path 17a and the path 17. If oxygen is needed, the professional may turns on a button which controls the release of gaseous oxygen from the oxygen source 20. To adjust the position of the outlet member 12 and the distance between the patient's nose and the tip of the outlet member 12 (or the extension 12a), the dental professional may simply bend the outlet member 12 according to the need.

The bi-functional dental apparatus described above changes the passive dental service time into a peaceful enjoyment of oxygen without the patient's additional time and effort. The apparatus is very useful and helpful for the seniors and patients who feel difficulty in lying on the dental operation bed for a long time. Due to the oxygen, the patient under dental care service may stay longer, comforter, and healthier during the service.

While one or more embodiments of the present invention have been illustrated above, the skilled artisan will appreciate that modifications and adoptions to those embodiments may be made without departing from the scope and spirit of the present invention.

1. An apparatus for the use in dental care service for providing gaseous oxygen to a patient and removing dental impurities from the patient's mouth concurrently, comprising:
a first bendable nozzle for dispensing gaseous oxygen to a space near the patient's nose;
a second bendable nozzle for sucking dental impurities from the patient's mouth;
a base comprising a source of oxygen and a vacuum suction; and
a flexible connector coupled between said base and said nozzles, said flexible connector comprising a first inner path connecting said first bendable nozzle to said source of oxygen and a second inner path connecting said second bendable nozzle to said vacuum suction.

2. The apparatus of claim 1, further comprising a first removable and disposable extension adapted to said first bendable nozzle.

3. The apparatus of claim 2, wherein said first removable and disposable extension is transparent or semi-transparent.

4. The apparatus of claim 3, wherein said first removable and disposable extension is in a color which is substantially same as that of said first bendable nozzle.

5. The apparatus of claim 1, further comprising a second removable and disposable extension adapted to said second bendable nozzle.

6. The apparatus of claim 5, wherein said second removable and disposable extension is transparent or semi-transparent.

7. The apparatus of claim 6, wherein said second removable and disposable extension is in a color which is substantially same as that of said second bendable nozzle.

8. The apparatus of claim 1, wherein said first bendable nozzle is thinner than said second bendable nozzle.

9. The apparatus of claim 1, wherein said first bendable nozzle is in a color different from that of said second bendable nozzle.

10. The apparatus of claim 1, wherein said first bendable nozzle is transparent or semi-transparent.

11. The apparatus of claim 1, wherein said second bendable nozzle is transparent or semi-transparent.

12. The apparatus of claim 1, wherein said flexible connector is transparent or semi-transparent.

13. The apparatus of claim 1, further comprising a connecting member coupled between said flexible connector and said nozzles, said connecting member comprising a third inner path connecting said first bendable nozzle to said first inner path of said connector and a fourth inner path connecting said second bendable nozzle to said second inner path of said connector.

14. The apparatus of claim 13, wherein said connecting member is transparent or semi-transparent.
